(19) United States
(12) Patent Application Publication
(10) Pub. No.: US 2007/0146464 A1
(43) Pub. Date: Jun. 28, 2007

(54) PRINTING MEDIUM, IMAGE OBJECT, AND IMAGE FORMING METHOD

(75) Inventor: Yoshiyuki SHINO, Yokohama-shi (JP)

Correspondence Address: FITZPATRICK CELLA HARPER & SCINTO, 30 ROCKEFELLER PLAZA, NEW YORK, NY, 10112, US

(73) Assignee: Canon Finetech Inc., Joso-shi (JP)

(21) Appl. No.: 11/613,391

(22) Filed: Dec. 20, 2006

(30) Foreign Application Priority Data
Dec. 26, 2005 (JP) 2005-371465

(51) Int. Cl. B41J 3/407

(52) U.S. Cl. 347/106

(57) ABSTRACT

A printing medium includes a substrate, a device provided on the substrate, which stores information accessible from outside, and an image printing part provided on the substrate, wherein said device is provided in a laminated position of the printing medium.

### BACKGROUND OF THE INVENTION

1. Field of the Invention

The present invention relates to a printing medium which is suitable as an identification tag for baggage and the like, and which has a built-in device such as RFID (Radio Frequency Identification) and the like that can write and readout information without contact. Also, the present invention relates to an image object that includes an image formed on the above-mentioned printing medium and an image forming method that forms an image on the above-mentioned printing medium.

2. Description of the Related Art

Presently, airport baggage is sorted and dispatched by visual recognition of the indication on the baggage tag or by bar code recognition and the like, and also when a passenger takes receipt of baggage at the destination airport, the baggage is recognized by visual inspection, and no particular automation is provided. However, this entails the following problems.

(1) There are cases in which airport baggage is sent to the airport separately from the passenger prior to the time of boarding, and the sorting and storage of the baggage is troublesome.

(2) It takes time to recognize the indications on airport baggage by visual inspection (by hand) or by barcode, and it is easy for mistakes to occur. For this reason, mishaps frequently occur where there is a mistake in the destination or flight.

(3) Because the sorting and conveyance of airport baggage according to the recognized indication is done by hand, the labor for such sorting and conveyance is excessive.

(4) It is laborious for passengers to recognize and pick up baggage by themselves at the destination airport, and it is a particular burden for elderly people or persons who are physically weak.

(5) In the same way, because passengers decide which baggage to pick up by visual inspection, there are cases where a person mistakenly or purposefully takes away another's baggage.

(6) Where one's baggage does not appear, one is uneasy not knowing if there was a mishap or if someone else took the baggage.

In order to solve such problems, baggage tags that contain a radio communication device that can write and readout information without contact such as RFID and systems that use such tags are recently attracting attention.

Japanese Patent Laid-Open No. 2001-240218 and Japanese Patent Laid-Open No. 2001-243502 disclose a baggage tag that includes an electronically processable and rewritable contactless IC and a rewrite display part that can visibly rewrite the display contents on the baggage tag and a system that uses the baggage tag.

However, because the baggage tags disclosed by Japanese Patent Laid-Open No. 2001-240218 and Japanese Patent Laid-Open No. 2001-243502 print using a thermal method, they possess the following problems.

(1) Thinning and fragmentation, etc. of writing occurs on an uneven surface where the IC is installed.

(2) It is necessary to provide an image display part that avoids the uneven surface where the IC is installed.

(3) Even if the surface where the IC part is not installed is flat, because thermal conductivity differs from place to place, it is difficult to obtain good printing characteristics (i.e., the printing characteristics deteriorate).

(4) When the baggage tag is used as an ID tag for baggage, because the IC is installed on a curved surface, there is the risk that it can easily be detached during distribution of the baggage.

(5) Because the IC is installed on a curved surface, it is weak against mechanical stress during distribution of the baggage.

### SUMMARY OF THE INVENTION

The present invention has been presented to solve the above problems and provides a printing medium that includes a device (for example, a radio communication device) with superior reliability and an image display with superior imaging aptitude.

Furthermore, the present invention provides an image object that includes an image formed on the above-mentioned printing medium and an image forming method that forms an image on the above-mentioned printing medium.

Furthermore, the present invention provides a printing medium that reduces thinning and fragmentation, etc. of writing on an uneven surface where an IC is installed.

Furthermore, the present invention provides a printing medium that can provide an image display that is not limited by the position of an installed IC.

Furthermore, the present invention provides a printing medium that can reduce deterioration of printing characteristics due to differences in thermal conductivity.

Furthermore, the present invention has as its object to provide a printing medium that can prevent problems caused by bending of ID tags when a baggage tag is used as an ID tag on baggage.

Furthermore, the present invention provides a printing medium (a printing medium with an internal IC) that has tolerance against mechanical stress.

A printing medium that is one aspect of the present invention includes a substrate, a device provided on the substrate that stores information accessible from outside, and an image printing part provided on the substrate, wherein the device is provided in a laminated position of the printing medium.

The above printing medium is laminated so as to overlap.

The above printing medium is laminated by being bent into a loop shape.

The above printing medium further includes an ink shielding structure near the device. The ink shielding structure is provided between the device and the image printing part.

In the above printing medium, the substrate is a porous film.

In the above printing medium, the substrate includes an ink acceptance layer on at least one surface.

In the above printing medium, the device is a wireless communication device. The device is an RF-ID device.

An image object that is another aspect of the present invention includes an image formed by ink on the above printing medium.

An image forming method that is still another aspect of the present invention includes the steps of forming an image by ink on the above printing medium.

Further features of the present invention will become apparent from the following description of exemplary embodiments with reference to the attached drawings.

### BRIEF DESCRIPTION OF THE DRAWINGS

FIGS. 1A and 1B are views of a printing medium as one aspect according to the present invention, FIG. 1A is a schematic sectional view of the printing medium, and FIG. 1B is a perspective plane view of the printing medium shown in FIG. 1A as seen from the A direction.

FIGS. 2A to 2D are views for explaining an image forming method as one aspect of the present invention, FIG. 2A is a schematic sectional view of the printing medium when an image is formed, FIG. 2B is a schematic plane view of the printing medium, on which the image is formed, FIG. 2C is a schematic sectional view of one example of the printing medium when used as an ID tag, and FIG. 2D is a schematic sectional view of a different example of the printing medium when used as an ID tag.

FIG. 3 is a schematic sectional view of the printing medium as one aspect of the present invention.

FIG. 4 is a schematic sectional view of the printing medium as one aspect of the present invention.

FIG. 5 is a perspective plane view of the printing medium as one aspect of the present invention.

FIG. 6 is a schematic perspective view of one example of the printing medium's product form as one aspect of the present invention.

FIG. 7 is a schematic sectional view of a printing apparatus that records information and forms an image to the printing medium as one aspect of the present invention.

### DESCRIPTION OF THE EMBODIMENTS

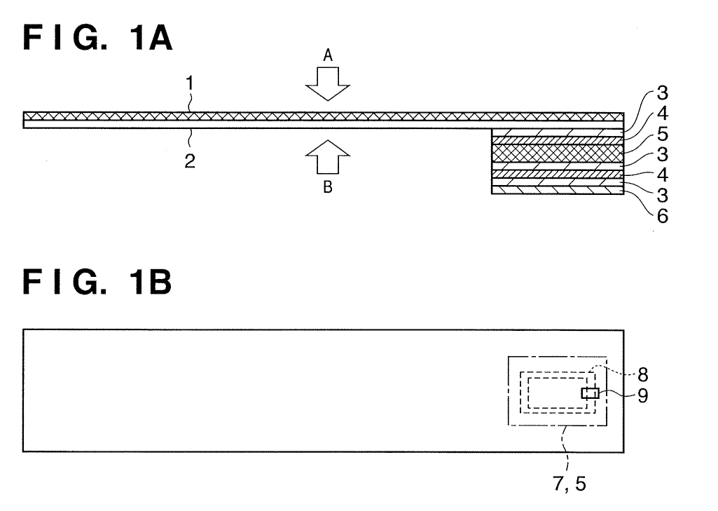

A detailed description will be given of preferred embodiments of the present invention with reference to the attached drawings. FIG. 1A is a schematic sectional view of a printing medium of the present invention. Here, 1 is an ink acceptance layer, which as shown in FIG. 1A is formed on one surface of a substrate 2. Also, an adhesive layer 3, an ink shielding structure 4, a wireless communication device 5, the adhesive layer 3, the ink shielding structure 4, the adhesive layer 3, and a release layer 6 are formed on a surface that is opposite to the surface formed by the acceptance layer 1.

FIG. 1B is a perspective plane view of the printing medium shown in FIG. 1A as seen from the A direction. In FIG. 1B, 7 is a wireless communication device (corresponding to the wireless communication device 5 shown in FIG. 1A), and includes, for example, a transmission and reception antenna 8 which is formed from a loop-shaped coil, etc. and an IC chip 9.

In order to use the printing medium of the present embodiment as an ID tag attached to baggage, as shown in FIGS. 1A and 1B, the wireless communication device 5 is provided in a lamination position of the printing medium (ID tag). Also, as described later, the printing medium may be laminated in a loop shape or laminated by bending (so as to overlap). Also, while in the present embodiment the printing medium is laminated together, it is also within the scope of the present invention to use a different medium for lamination.

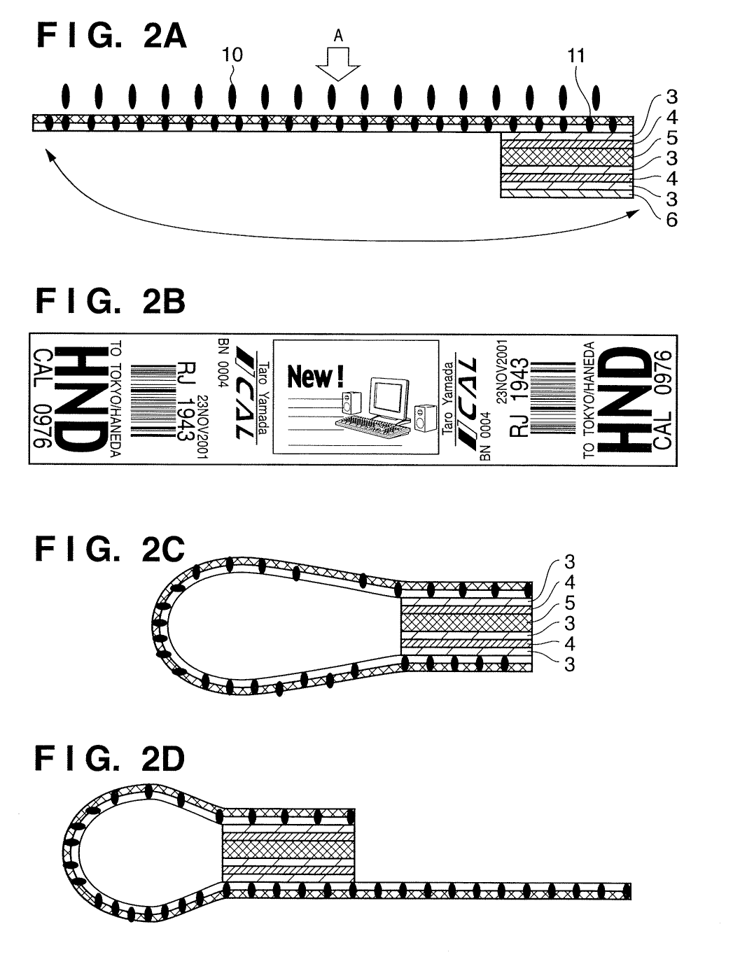

FIGS. 2A and 2D are views for explaining an image forming method as one aspect of the present invention that forms an image on the printing medium and a method for attaching the printing medium, on which the image is formed, to baggage and using the printing medium as the ID tag. In FIGS. 2A to 2D, the same reference numerals denote the same elements as in FIGS. 1A and 1B. Therefore, duplicate descriptions will be omitted.

Referring to FIG. 2A, an image 11 is formed by dropping drops of ink 10 onto the printing medium from the A direction. FIG. 2B is a plane view of the printing medium after forming the image 11 as seen from the A direction. The printing medium of the present embodiment, as shown in FIG. 2B, regardless of the position in which the wireless communication device 5 (7) is installed (placed), has printed on the entire surface of the printing medium as visually recognizable information the flight number of the passenger's flight, the passenger name, the date of issue of the baggage tag, a barcode, advertising, and the like. If the baggage tag issuing system disclosed by Japanese Patent Laid-Open No. 2003-306228 is used, visually recognizable information such as advertising suitable to the passenger and a photograph of the passenger's face can be printed.

Also, aside from the above normal visually recognizable information, the passenger's sex, the passenger's age, the date and time of issuance of the baggage tag, security check information concerning the baggage, passenger confirmation information recording that the passenger has boarded the flight, an ID number used when referring to recorded information in a database, and falsification prevention processing such as an electronic watermark and the like are stored (recorded) as electronic information in the wireless communication device 5 (7).

FIG. 2C is a view of the case in which the printing medium of the present embodiment is used as the ID tag attached to baggage. If the image 11 is formed on the printing medium, the release layer 6 is removed, it is adhered to itself through the handle, etc. of the baggage, and the printing medium on which the image 11 has been formed is used as the ID tag. In the present embodiment, the wireless communication device 5 (7) is provided in a laminated position of the printing medium (i.e., the position where end portions of the printing medium are overlapped). In other words, the printing medium of the present embodiment has a structure in which without exposing the wireless communication device 5 (7), it is provided in a relatively flat position. Thus, the printing medium of the present embodiment can protect the wireless communication device 5 (7) from external effects (water, humidity, temperature) during transport of baggage, and moreover, when used as an ID tag it also can protect the wireless communication device 5 (7) from mechanical stress during transport of baggage. Further, because it is difficult to visually ascertain the placement of the wireless communication device 5 (7) from the exterior, security is improved during transport. A falsification prevention layer may be independently provided on the image object to improve security.

FIG. 2D is a schematic sectional view of another embodiment when using the printing medium of the present embodiment as an ID tag attached to baggage (i.e., the embodiment differs from the embodiment of the printing medium shown in FIG. 2C). The printing medium of the present embodiment, as shown in FIG. 2D, is not laminated together at the end portions, but the laminated position can be changed to suit its intended use. While the printing medium is laminated together in FIG. 2D, the printing medium may be laminated to an other medium.

Hereinafter, a description will be given of the composition of materials used in the printing medium.

(Wireless Communication Device)

The wireless communication device 5(7) includes electrically connected elements such as a CPU and memory necessary to write or readout information without contact, and is not particularly limited. The wireless communication device 5(7) forms, for example, a resonance circuit by a coil pattern on a base of plastic, etc. and a capacity device, and it can communicate by receiving radio waves with a predetermined frequency. Generally, radio waves with the frequency band of 125 kHz, 13.56 MHz, 2.45 GHz (microwaves) are used as the radio waves, and in the case of microwaves the communication distance is several meters. While the wireless communication device 5(7) can be formed in a size approximately equal to or less than 30 mm×30 mm, when the printing medium is used as the baggage tag, because the printing medium has a very large surface area, it is possible to configure the size relatively freely.

Also, the transmission and reception antenna 8 may be formed either by a coil of fine wire or by printed wiring technology or photo-etching on a core sheet. Also, a wireless communication device that has a deactivator function may be used as the wireless communication device 5(7).

(Substrate)

The substrate 2 used in the printing medium of the present embodiment can use, as shown in FIGS. 1A and 1B, any substrates that support the ink acceptance layer 1, the adhesive layer 3, the ink shielding structure 4, the wireless communication device 5 (7), and the release layer 6, and is conveyed by a printer.

However, from the point of view of aptitude for inkjet printing and from the point of view of tolerance to severe environment during the transport of baggage, it is preferable that the substrate 2 uses a film or sheet that includes air fine holes (hereinafter referred to collectively as “porous film”). By forming the substrate 2 from a porous material, the water, etc. solvent (dispersion medium) in the ink used on the printing medium is most quickly absorbed, and it is possible to improve its quick drying characteristics.

The porous film is not particularly limited if it has the above effects, and can use materials that have been used for conventional image printing media. Specifically, the porous film can use polyethylene, polypropylene, polyolefin such as polymethylpentene-1, polyvinyl chloride, polystyrene, styrene-butadiene-acrylonitrile copolymer, polyamide, polymethyl methacrylate, polyester, and the like as materials, and can use any combination thereof. Also, as commercial products, PPG Industries Inc.'s porous extended resin film, Teslin (trademarked) resin film, and the like are also suitable as the porous film.

The substrate 2 is composed of a porous film that includes air fine holes and has permeability. If the permeability is specified using Gurley air permeability, the permeability is usually within the range of 10 to 3,000 seconds per 100 mL, but it is preferable that it be in the range of 50 to 2,500 seconds per 100 mL, and further preferable that it be in the range of 100 to 200 seconds per 100 mL.

The Gurley air permeability in the present embodiment conforms to JISP-8117-1980, is a value measured using a Gurley air permeability testing machine, and normally indicates the time needed for air with a volume of 100 mL to pass through. The porosity of the porous film (a void volume occupying the volume of the entire film) is normally 10 to 90 percent of the volume, and it is preferable that it is 20 to 80 percent of the volume. Also, the diameter of the hole measured perpendicularly to the thickness cross section direction of the film is normally 0.01 to 3 μm, and is preferable to be 0.02 to 2 μm, and is further preferably 0.03 to 1 μm. The total thickness of substrate 2 is 30 to 500 μm, and is preferably 50 to 300 μm. If the thickness of substrate 2 is extremely thin, the ink quick drying characteristics deteriorate and the substrate 2 is damaged during transport of baggage. If the thickness of substrate 2 is extremely thick, handling of the printing medium during conveyance by the printer is inconvenient.

A hydrophilization processing is preferably treated to the surface of substrate 2 and the air fine holes by a surface active agent to effectively improve the quick drying characteristics of the printed ink image. Any one of an anionic, cationic, amphoteric, or nonionic may be used as the surface active agent. The anionic can use, for example, a carboxylic acid salt, a sulfonic acid salt, a phosphoric ester salt, and the like. The cationic can use, for example, an amine salt, a quaternary ammonium salt, and the like. The amphoteric can use, for example, a betaine, a sulphobetaine, and the like. The nonionic can use, for example, polyoxyalkylene such as a polyethylene glycol, sorbitan, sorbiyol, and the like.

The hydrophilization processing can be executed simultaneously with forming the ink acceptance layer 1 by adding the surface active agent to the application liquid to form the ink acceptance layer 1 and applying the application liquid to the surface of the substrate 2. Also, the hydrophilization processing can be executed before forming the ink acceptance layer 1. For example, it is desirable, first, to apply the liquid containing the surface active agent to the surface of the substrate 2, or after executing the hydrophilization process by impregnating the substrate 2 into the liquid, by applying a liquid containing a polymer and an agglomerate reagent, forming the ink acceptance layer 1 on the surface of the substrate 2 treated with the hydrophilization process. Thereby, it is possible to easily manufacture a printing medium (image printing medium) that has quick drying characteristics. As mentioned above, if the hydrophilization process is executed by applying and drying the liquid containing the surface active agent, it is desirable to use solvent water or ethanol, etc. alcohol. The concentration of the surface active agent in the liquid containing the surface active agent is normally 1 to 30 percent of mass, and preferably 5 to 25 percent of mass. Also, a normal coater such as, for example, a bar coater, knife coater, roll coater, or die coater may be used as an application apparatus for application of the liquid.

The porous film may be made to contain necessary inorganic microscopic powder. The inorganic microscopic powder can use calcium carbonate, alumina, fired clay, silica (including amorphous silica), diatomaceous earth, talc, titanium oxide, barium sulfate and the like. The particle diameter of the microscopic powder is normally 0.3 to 10 μm, and desirably 0.8 to 5 μm. Also, other additives such as a heat stabilizer, an ultraviolet absorber, a dispersant, an antistatic agent, an antioxidant, and oil (mineral oil) and the like may be compounded into the porous film. If the above substrate 2 is used, even if the ink acceptance layer 1 is not particularly formed, if the formation of visually recognizable information with high quality is not demanded, it is possible to form an image. For example, even from the B direction shown in FIG. 1A, in the area of substrate 2 in which the adhesive layer 3, the ink shielding structure 4, the wireless communication device 5 (7), and the release layer 6 are not formed, it is possible to print the image as an inkjet image.

(Ink Acceptance Layer)

While it is possible to suitably use known materials for the materials that form the ink acceptance layer 1 of the printing medium of the present embodiment, it is preferable to include an organic polymer and an agglomerate reagent containing water soluble organic acid or inorganic acid salt. This type of agglomerate reagent has a function of causing speedy agglomeration of coloring components such as pigments and the like on the surface of the ink acceptance layer 1 when water-color ink is applied (printed, etc.) on the surface of the medium. Thus, it is possible to effectively prevent the transference of pigments and the like as far as within the pores in the medium, improving the quick drying. Also, if the ink acceptance layer 1 includes an organic polymer in addition to an agglomerate reagent, due to the synergistic effect of the above agglomeration action and the polymer's binding action, it is possible to effectively improve the water resistance of the ink image that has fixed to the surface. The ink acceptance layer 1 may be a single layer, and may be a multiple layers to add higher performance.

If the polymer of the ink acceptance layer 1 is a polar polymer including polar functional groups within its molecules, the agglomeration action of the water-color ink can be effectively improved by the synergistic effect of the agglomerate reagent and the polar polymer. Cation denatured polyurethane or a basic polymer such as polyvinyl pyrrolidone and the like are preferable as such polar polymer. The organic polymer can also use polyolefin, polyvinyl chloride, polystyrene, styrene-butadiene-acrylonitrile copolymer, polyamide, acrylic polymer, polyester, normal (non-denatured) polyurethane and the like in addition to the above mentioned cation denatured polyurethane.

It is desirable that a polyhydric metal salt is used as the organic or inorganic acid salt. This is because there is a relatively high agglomeration action while at the same time it is excellent in improving the effect of quick drying and water resistance of the fixed ink image. A polyhydric metal ion can use one or two or more in combination of the following: aluminum, gallium, titanium, zirconium, hafnium, zinc, magnesium, calcium, niobium, tantalum, iron, copper, tin, cobalt and the like.

As an inorganic acid, sulfuric acid, nitric acid, or hydrochloric acid is desirable. If the organic polymer is cation denatured polymer such as cation denatured polyurethane and the like, the non-organic acid salt is desirable over the organic acid salt. This is because the effects of quick drying and water resistance can be effectively increased. Aluminum sulfate is desirable as an inorganic acid salt. This is because it is thought that it is possible to effectively increase the ink adherence power through the synergistic effect of the cation portion of the polymer and the sulfuric acid ions and aluminum ions.

As organic acids, it is desirable to use aromatic carboxylic acid, sulfonic acid, sulfocarboxylic acid, hydroxysulfocarboxylic acid or hydroxycarboxylic acid. Also, it is possible to use either one or a combination of two or more of these acids. The amount of agglomeration reagent included in the ink acceptance layer 1 is for every 100 parts per mass of organic polymer, normally 1 to 70 parts per mass, desirably 3 to 50 parts per mass, and even further desirable to be 5 to 30 parts per mass. If the amount of agglomeration reagent is extremely small, there are cases where the ink adherence power decreases and the water resistance and color development decrease. Also, if the amount of agglomeration reagent is extremely large, a bleeding of ink image occurs.

In the ink acceptance layer 1, in order to improve the porosity of the ink acceptance layer 1, it is also possible to include as necessary inorganic microscopic powder. The inorganic microscopic powder can use calcium carbonate, alumina, fired clay, silica (including amorphous silica), diatomaceous earth, talc, titanium oxide, barium sulfate and the like. The particle diameter of the microscopic powder is normally 0.3 to 10 μm, and desirably 0.8 to 5 μm. Also, other additives such as a heat stabilizer, an ultraviolet absorber, a dispersant, an antistatic agent, an antioxidant, oil (mineral oil) and the like may be compounded into the ink acceptance layer 1. The thickness of the ink acceptance layer 1 is not limited to the extent that the effect of the invention is not harmed. If the ink acceptance layer 1 is extremely thin, the ink quick drying decreases and the ink acceptance layer 1 is damaged during transport of baggage. If the ink acceptance layer 1 is extremely thick, the handling of the printing medium by the printer is inconvenient. Therefore, the thickness of the ink acceptance layer 1 is normally 5 to 200 μm, and is preferably 10 to 100 μm. The ink acceptance layer 1 is formed by, for example, applying a liquid containing the agglomeration reagent and the organic polymer and drying it. In this case, it is desirable to use water or alcohol as a solvent. Also, a normal coater such as, for example, a bar coater, knife coater, roll coater, or die coater may be used as an application apparatus.

In order to improve the inkjet printing aptitude, for example, beading resistance or blocking resistance and the like, and moreover, in order to improve the obtainable preservability of the printed inkjet object, for example, the bleeding of the image in a high humidity environment or water resistance and the like, aside from the above materials, a hydrosoluble micromolecular organic compound and a cation compound, and a non-hydrosoluble organic compound may be used as appropriate.

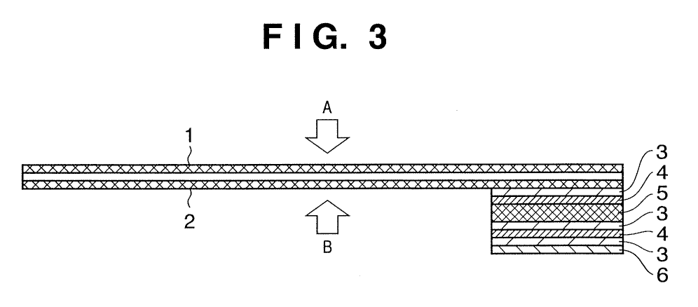

Also, as shown in FIG. 3, the ink acceptance layer 1 may be formed on both surfaces of the substrate 2. Thereby, it is possible to form the inkjet image with high quality from direction B also. Here, FIG. 3 is a schematic sectional view of another embodiment of the printing medium according to the present invention.

(Ink Shielding Structure)

When the present embodiment's printing medium is used as the ID tag, the ink shielding structure 4, specifically, is a structure that is necessary so that the ink component that is applied to an image part (ink acceptance layer 1) does not reach the wireless communication device 5 (7). In the present embodiment, the printing medium has a structure in which the ink shielding structure 4 is provided between the substrate 2 and the wireless communication device 5 (7), and it is configured so that the ink component that is applied by printing does not reach from the image part by diffusion/permeation to the wireless communication device 5 (7).

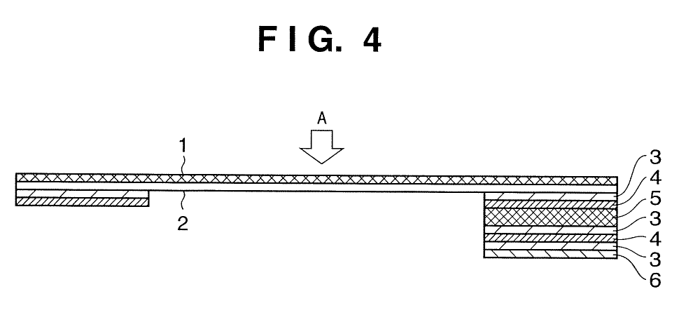

Therefore, the ink shielding structure 4 is not particularly limited if it is provided between the image part and the wireless communication device 5 (7), and may be provided in any position. For example, as shown in FIG. 4, it is possible to provide for the ink shielding structure 4 in another lamination portion. FIG. 4 is a schematic sectional view of another embodiment of the printing medium according to the present invention.

It is possible to use, for example, already publicly known coupling agents (silane, titanium), a surface active agent, and resin (including emulsion) as the materials that form the ink shielding structure 4. Note that in the ink shielding structure 4, resin is preferable to use particularly from the point of view of ease of forming a uniform and strong continuous film. The resin can use, for example, polyethylene, polypropylene, polystyrene, polyisoprene, cellulose, cellulose acetate, polyvinyl acetate, polyvinyl acetate, poly(estermethacrylate), polyester, polycarbonate, epoxy resin, phenol resin, alkyd resin, polyacrylonitrile, polyamide, urea resin, melamine resin, urethane resin, polyvinyl chloride, polyvinylidene chloride, chloroprene, polyfluoroethylene, polytrifluorochloroethylene, silicone resin and the like, but it is preferable to select one that has exceptional water resistance, alkali resistance, and acid resistance. Also, it is desirable that the resin used be of high purity, with impurities such as alkali metal ions and chloride ions removed.

It is preferable that the thickness of the ink shielding structure 4 be 0.1 to 100 [μm]. If the thickness of the ink shielding structure 4 is extremely thin, the ink shielding structure 4 will be damaged by the severe environment during transport of baggage. If the ink shielding structure 4 is extremely thick, handling of the printing medium by the printer is inconvenient.

However, the ink shielding structure 4 is not limited to the above embodiment. For example, the ink shielding structure 4 may be formed by composing the ink acceptance layer 1 and substrate 2 of the above materials, or by using the substrate 2 that has a surface processed by a separating process, or by using the substrate 2 consisting of water repellant material.

(Adhesive Layer)

The adhesive layer 3 is used when laminating the present embodiment's printing medium through the handle of a piece of baggage. Also, the adhesive layer 3 is used to bond the substrate 2 to the ink shielding structure 4, and the ink shielding structure 4 to the wireless communication device 5 (7). Therefore, while the adhesive contained in the adhesive layer 3 is not particularly limited, it is preferable to use a polymer that can be used as a pressure sensitive adhesive and that has adhesive properties at normal temperatures. For example, the adhesive layer 3 can use various types of publicly known solvent-type/non-solvent type adhesives, such as gum, acrylic, silicone, polyester, and vinyl ether. Gum type adhesives contain as primary raw materials natural gum and styrene-butadiene gum, rosin resin and various types of plasticizer. Also, it is possible to use as necessary in the adhesive layer 3 a thermoplastic resin or a hot-melt adhesive or a delayed adhesive or a self-adhering pressure sensitive adhesive.

(Release Layer)

The release layer 6 has a function of protecting the adhesive layer 3. The release layer 6 is not particularly limited if it has a separating layer on a publicly known substrate such as paper and film. Also, after the image is formed on the present medium in the present embodiment, the release layer 6 is removed and used to laminate the adhesive layer 3 to the back surface of the substrate 2. Therefore, in order to improve handling, the release layer 6 may have an area larger than the adhesive layer 3. Materials that may be used in the separating layer are, first, as a heat melt material, waxes such as carnauba wax, paraffin wax, microcrystalline wax, and castor wax, and higher fatty acids such as stearic acid, palmitic acid, lauric acid, aluminum stearate, lead stearate, barium stearate, zinc stearate, zinc palmitate, methyl-hydroxy stearate, and glycerol-mono-hydroxy stearate,] or their metallic salts; olefin resins such as derivatives of ester and the like, polyamide resins, oil resins, rosin derivatives, chroman-indene resin, terpene resins, novolac resins, styrene resins, polyethylene, polypropylene, polybutene, and polyolefin oxide; and vinyl-ether resins and the like. Also, it is possible to use silicone resin, fluorosilicone resin, fluoro-olefin-vinyl-ether-terpolymer, perfluoro-epoxy resin, thermosetting acrylic resin having in branch a base of perfluoro-alkyl, vinylidene fluoride thermosetting paint and the like.

Next, a description will be given of another embodiment of the printing medium according to the present invention.

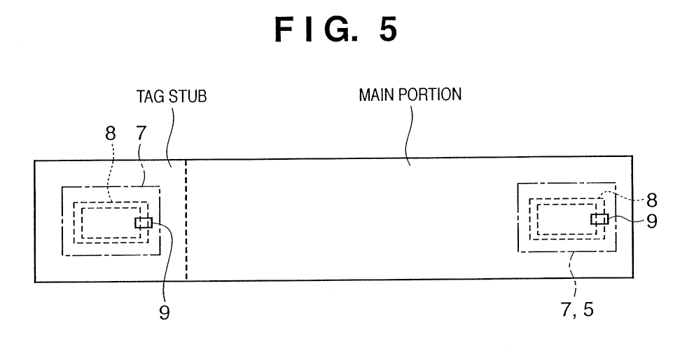

FIG. 5 is a penetration plane view of another embodiment of the printing medium according to the present invention. The printing medium shown in FIG. 5 includes a tag stub, and the wireless communication device 5 (7) is also provided in the tag stub. The same contents that are recorded in the IC chip 9 of a main portion of the printing medium are recorded in an IC chip 9 that constitutes the wireless communication device 5 (7) of the tag stub. Therefore, the tag stub can be used as an ID tag when automatically taking receipt of baggage, and it is possible to automatically pick baggage even if the passenger does not have a boarding pass. Also, the required number of tag stubs may be added as necessary.

(Product Form)

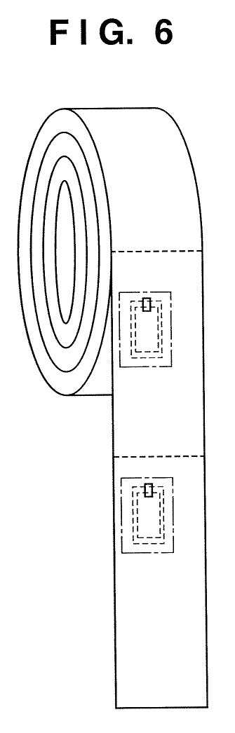

As shown in FIGS. 1A and 1B, the printing medium of the present embodiment may be processed in a tag form, and as shown in FIG. 6, it may be processed in the form of a continuous roll of paper and cut off after forming an inkjet image. In other words, the printing medium of the present embodiment can select the product form according to the printing process (process of forming the image). For example, the form of continuous paper is not limited to the roll form and may be a fold form.

(Method of Recording)

A publicly known ink may be used when printing on the present embodiment's printing medium. The ink can use water soluble dyes represented in direct dye, acid dye, basic alkaline dye, reactive dye, and food coloring, and is not particularly limited if it is a normally used inkjet printer ink.

Even among the above inks, it is desirable to use ink containing direct dye and/or alkaline dye. Also, taking into consideration the weather resistance of the final image object, it is possible to use water-based pigments and oil-based pigments.

(Inkjet Recording Method)

A description will be given of an inkjet printing method. If the inkjet printing method is used as the method of printing an image on the printing medium, because it is possible to form the image without direct contact, it is possible to print (form) an image on the entire surface of the printing medium regardless of the position of the wireless communication device 5 (7). The inkjet recording method uses various drive principles and prints by discharging small drops of ink from nozzles, and it is possible to use existing publicly known printing methods.

For example, as stated in Japanese Patent Laid-Open No. 54-59936, it is possible to use the inkjet method of causing sudden volume changes in the ink by operation of thermal energy and causing discharge of ink from nozzles by force of action due to said changes in condition.

Hereinafter, a description will be given of a printing apparatus that is suitable for printing onto the printing medium of the present embodiment.

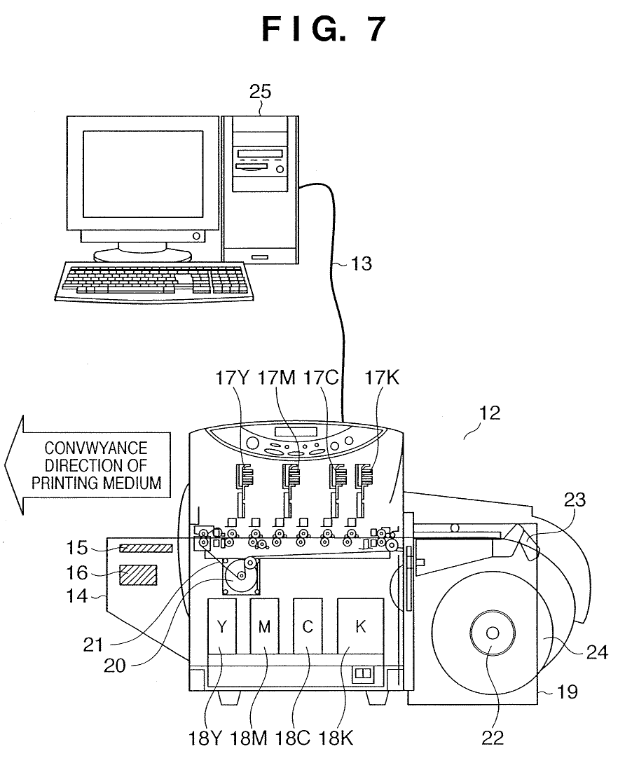

FIG. 7 is a schematic sectional view of a printing apparatus that writes information into the wireless communication device 5 (7) and forms an image on the ink acceptance layer 1.

The printing apparatus 12 is a printer that prints on the printing medium. The printing apparatus 12 mounts the printing medium on a roll unit 19 and feeds it to a conveyance part.

The conveyance part consists primarily of a conveyance motor 20 and a conveyance belt 21, and when printing it has a function of conveying the printing medium in the direction of the arrow in FIG. 7.

Here, the roll unit 19 side of the conveyance path is the conveyance entryway and the side opposite to the roll unit 19 is the conveyance exit. The printing apparatus 12 includes ink jet printing heads with black (K) head 17K, cyan (C) head 17C, magenta (M) head 17M, and yellow (Y) head 17Y as a printing unit, and these line heads have a row of nozzles spanning the width of the label.

K, C, M, Y ink is selectively discharged from these respective four heads 17K through 17Y, printing a color image.

The discharged ink is supplied to each of the ink cartridges black (K) ink cartridge 18K, cyan (C) ink cartridge 18C, magenta (M) ink cartridge 18M, and yellow (Y) ink cartridge 18Y by a pump (not shown).

The roll unit 19 includes a roll drive spindle 22 which mounts the present embodiment's printing medium 24, a roll sensor lever 23 which changes position depending on the slack in the printing medium 24, and a roll motor (not shown) which drives the roll drive spindle 22, and the printing medium 24 is supplied by the roll motor either driving or stopping depending on the situation of the roll sensor lever 23.

Moreover, the printing apparatus 12 is connected to a host computer 25 by a cable 13. The host computer 25 transfers as control commands printing data and information to be written onto the printing medium's wireless communication device 5 (7) to the printing apparatus 12.

Also, a non-contact communication part 14 for writing information onto the printing medium's wireless communication device 5 (7) is provided near the conveyance exit. The non-contact communication part 14 includes a communication antenna 15 and a non-contact reader writer 16 that controls communication with the wireless communication device 5 (7).

Using this type of printing apparatus 12, it is possible to write information onto the wireless communication device 5 (7) that is built into the printing medium at the same time that an image is printed.

The present invention can maintain a wireless communication device in an appropriate and normal manner, and provide a printing medium that includes an overall superior inkjet printing part. Also, in the present invention's printing medium, when the printing medium is used as an identification tag attached to baggage (baggage tag), because the wireless communication device is provided in the lamination position, it is configured so that the wireless communication device is not exposed and it is possible to protect the wireless communication device from outside effects (water, humidity, heat) during transport of baggage. Moreover, when the printing medium is used as an ID tag attached to baggage (baggage tag) the wireless communication device, because it is located in a relatively flat position, is also protected from mechanical stress during transport of baggage. Because the fact that the wireless communication device is installed is difficult to ascertain visually from the outside, security during transport of baggage is improved. Also, this invention's printing medium includes an image printing part that is printed by inkjet, and because an image can be printed on the image printing part without contact, it is possible to execute processing of both the wireless communication device and the image printing part without contact. Therefore, even if a projection part forms on the printing medium (image printing part) due to the wireless communication device, this does not bring about a hindrance to image forming, and furthermore, it is possible to form an image on the image printing part over the wireless communication device.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2005-371465, filed on Dec. 26, 2005, which is hereby incorporated by reference herein in its entirety.

What is claimed is:

1. A printing medium comprising:
a substrate;
a device provided on the substrate, which stores information accessible from outside; and
an image printing part provided on the substrate,
wherein said device is provided in a laminated position of the printing medium.

2. A printing medium according to claim 1, wherein said printing medium is laminated so as to overlap.

3. A printing medium according to claim 1, wherein said printing medium is laminated by being bent into a loop shape.

4. A printing medium according to claim 1, further comprising an ink shielding structure near the device.

5. A printing medium according to claim 4, wherein said ink shielding structure is provided between the device and the image printing part.

6. A printing medium according to claim 1, wherein said substrate is a porous film.

7. A printing medium according to claim 1, wherein said substrate includes an ink acceptance layer on at least one of its surfaces.

8. A printing medium according to claim 1, wherein said device is a wireless communication device.

9. An image object comprising an image formed by ink on a printing medium according to claim 1.

10. An image forming method comprising the steps of forming an image by ink on a printing medium according to claim 1.
